(19) United States
(12) Patent Application Publication
(10) Pub. No.: US 2012/0121143 A1
(43) Pub. Date: May 17, 2012

(54) FINGERPRINT IMAGING SYSTEM

(76) Inventor: Hung-Te Lee, Taipei (TW)

(21) Appl. No.: 12/944,339

(22) Filed: Nov. 11, 2010

(51) Int. Cl. G06K 9/00

(52) U.S. Cl. 382/125

(57) ABSTRACT

A fingerprint imaging system includes an image capturing apparatus that includes an optical component having a sensing surface for placing a fingertip thereon, an inclined reflection surface that is connected to the sensing surface, and a light exit surface that is disposed opposite to the inclined reflection surface. The image capturing apparatus also includes a light source module for directing a light beam towards the sensing surface for scattering by a fingerprint of the fingertip placed on the sensing surface. The light source module, and the various surfaces of the optical component are disposed such that light scattered by a plurality of ridges of the fingerprint form a light component that is reflected to exit the optical component through the light exit surface. The image capturing apparatus further includes an imaging unit.

### BACKGROUND OF THE INVENTION

1. Field of the Invention

The invention relates to a fingerprint imaging system, and more particularly to an optical fingerprint imaging system and its application for fingerprint recognition.

2. Description of the Related Art

Referring to FIG. 1, in U.S. Pat. No. 7,158,659, a conventional fingerprint imaging system 1 is disclosed. The conventional fingerprint imaging system 1 includes a light emitting diode (LED) module 11, a first prism 12, a second prism 14, and an image sensing module 15 disposed below the second prism 14. The first prism 12 includes an inclined first surface 120, a sensing surface 121 connected to the first surface 120 for placing a finger 19 thereon, and a second surface 122 disposed opposite to the first surface 120.

Light provided by the LED module 11 enters the first prism 12 from the first surface 120 and propagates toward the sensing surface 121 and the finger 19. The light is subsequently reflected from the ridges and the valleys of the fingerprint on the finger 19 back to the first surface 120 before being further reflected towards the second prism 14. The light is reflected by the second prism 14 towards the image sensing module 15.

Because the ridges and the valleys of the fingerprint have similar skin color, insufficient contrast between the ridges and valleys may make it difficult for the conventional fingerprint imaging system 1 to either identify fingerprint features or to accurately track movement of the finger 19.

### SUMMARY OF THE INVENTION

An object of the present invention is to provide a miniaturized fingerprint imaging system that is suitable for finger recognition and finger navigation, and that can obtain fingerprint images with good contrast quality.

According to one aspect of the present invention, a fingerprint imaging system includes an image capturing apparatus that includes an optical component having a sensing surface for placing a fingertip thereon, a total internal reflection surface that is disposed opposite to the sensing surface, an inclined reflection surface that is connected to the sensing surface and the total internal reflection surface and that forms an acute angle with the total internal reflection surface, and alight exit surface that is disposed opposite to the inclined reflection surface.

The image capturing apparatus also includes a light source module for directing a light beam towards the sensing surface for scattering by a fingerprint of the fingertip placed on the sensing surface. The light source module, the sensing surface, the total internal reflection surface, the inclined reflection surface and the light exit surface are disposed such that light scattered by a plurality of ridges of the fingerprint form a first light component that is reflected through total internal reflection to the inclined reflection surface so as to exit the optical component through the light exit surface, and such that light scattered by a plurality of valleys of the fingerprint form a second light component that passes through the total internal reflection surface.

The image capturing apparatus further includes an imaging unit including an imaging lens disposed to receive light from the light exit surface, and an imaging sensor disposed to receive light that passes through the imaging lens so as to form a fingerprint image. The fingerprint imaging system further includes an image processing apparatus coupled to the imaging sensor for receiving the fingerprint image therefrom.

In another aspect, the fingerprint imaging system includes an image capturing apparatus that includes an optical component having a sensing surface for placing a fingertip thereon, an inclined reflection surface that is connected to the sensing surface at an acute angle, and a light exit surface that is disposed opposite to the inclined reflection surface. The image capturing apparatus further includes a light source module for directing a light beam towards the sensing surface for scattering by a fingerprint of the fingertip placed on the sensing surface. The light source module, the sensing surface, the inclined reflection surface and the light exit surface are disposed such that light scattered by a plurality of ridges of the fingerprint form a first light component that is reflected by the inclined reflection surface so as to exit the optical component through the light exit surface, and such that light scattered by a plurality of valleys of the fingerprint form a second light component that is not reflected by the inclined reflection surface for exiting through the light exit surface.

The image capturing apparatus also includes an imaging unit including an imaging lens disposed to receive light from the light exit surface, and an imaging sensor disposed to receive light that passes through the imaging lens so as to form a fingerprint image. The fingerprint imaging system further includes an image processing apparatus coupled to the imaging sensor for receiving the fingerprint image therefrom.

Preferably, the sensing surface is in a form of a strip that extends across the fingerprint placed thereon, and the fingerprint image from the imaging unit corresponds to a widthwise section of a full fingerprint pattern of the fingerprint placed on the sensing surface. The image processing apparatus includes a first processing unit operable in a finger recognition mode. The first processing unit has an image receiving module for storing consecutive ones of the fingerprint images of the fingertip placed on the sensing surface. The consecutive ones of the fingerprint images are acquired by the imaging sensor when the fingertip is moved transverse to the sensing surface. The image receiving module is further operable to compose the full fingerprint pattern of the fingerprint placed on the sensing surface. The first processing unit further has a feature extracting module coupled to the image receiving module for extracting at least one feature of the full fingerprint pattern, and a comparison module for comparing the at least one feature of the full fingerprint pattern with a pre-established data set for identification of the fingerprint.

Preferably, the image processing apparatus further includes a second processing unit operable in a finger navigation mode for generating a cursor control signal based on a relative displacement of the fingertip relative to the sensing surface. The relative displacement is determined through analyzing the consecutive ones of the fingerprint images acquired by the imaging sensor.

Preferably, the sensing surface includes a first image sensing region for the finger recognition mode, and a second image sensing region for the finger navigation mode.

Preferably, the sensing surface has an area smaller than that of the fingerprint placed thereon. The fingerprint image from the imaging unit corresponds to a section of a full fingerprint pattern of the fingerprint placed on the sensing surface. The image processing apparatus includes a processing unit operable in a finger navigation mode for generating a cursor control signal based on a relative displacement of the fingertip relative to the sensing surface. The relative displacement is determined through analyzing the consecutive ones of the fingerprint images acquired by the imaging sensor.

Preferably, the optical component includes a pair of lateral walls, each connected between corresponding lateral sides of the sensing surface and the total internal reflection surface. The light source module includes first and second light sources each disposed proximate to a lower portion of a corresponding one of the lateral walls of the optical component.

Preferably, the light source module is disposed below the optical component for illuminating the sensing surface.

Preferably, the light exit surface is formed with a negative curvature.

Preferably, the imaging unit further includes an aperture stop disposed between the light exit surface and the imaging lens.

The design of the optical component permits the imaging sensor of the imaging unit to receive only the scattered light components reflected from the ridges of the fingerprint, such that images received by the imaging sensor have better contrast quality over the prior art. The image processing apparatus can therefore provide improved finger recognition and finger navigation. Moreover, the design of the optical component permits further miniaturization of the image capturing apparatus with respect to the prior art.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic diagram illustrating a conventional fingerprint imaging system;

FIG. 2 is a schematic diagram of the first preferred embodiment of a fingerprint imaging system according to the present invention;

FIG. 3 is a top schematic diagram of an image capturing apparatus of the first preferred embodiment;

FIG. 4 is a diagram illustrating consecutive partial images of a fingerprint captured when a fingertip is moved over a sensing surface;

FIG. 5 is schematic block diagram illustrating a first processing unit of an image processing apparatus of the first preferred embodiment;

FIG. 6 is a schematic diagram of a modification of the first preferred embodiment;

FIG. 7 is a schematic diagram of another modification of the first preferred embodiment;

FIG. 8 is a schematic diagram of the second preferred embodiment of a fingerprint imaging system according to the present invention;

FIG. 9 is a top schematic diagram illustrating the image capturing apparatus of the second preferred embodiment;

FIG. 10 is a schematic diagram of a modification of the second preferred embodiment; and

FIGS. 11A to 11C are schematic diagrams illustrating first and second photo detector arrays of an imaging sensor.

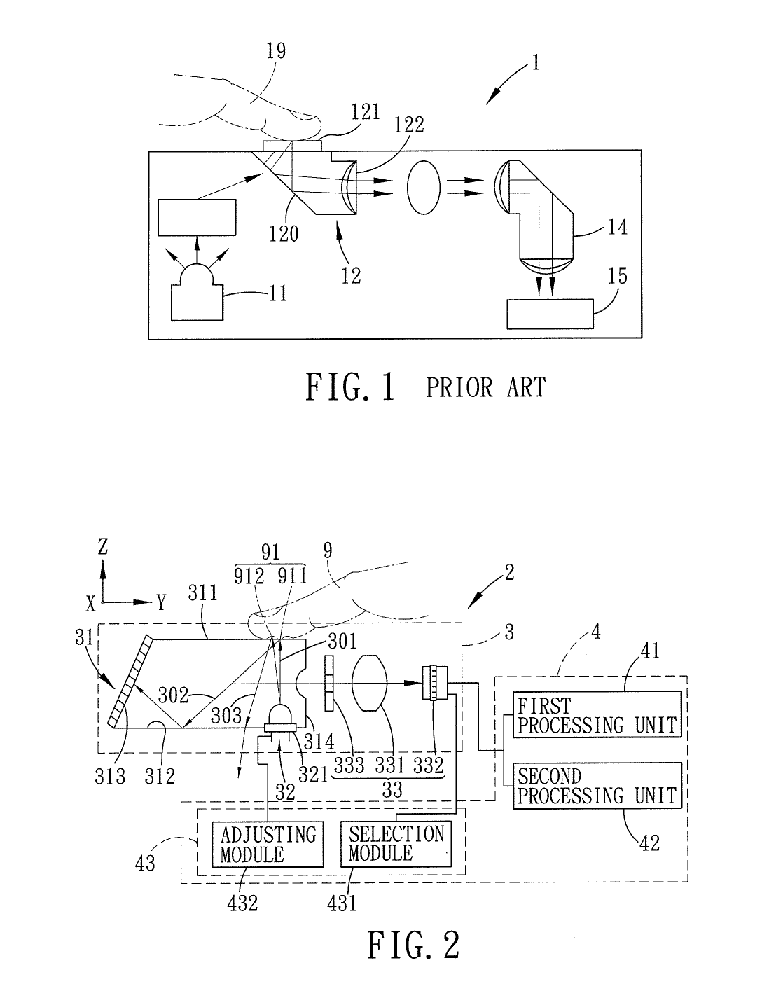

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

Referring to FIG. 2, the first preferred embodiment of a fingerprint imaging system 2 according to the present invention is shown to be adapted to be mounted in an electronic product (not shown in the Figure), such as a mobile phone, a notebook computer, etc., for performing finger recognition and finger navigation. The fingerprint imaging system 2 comprises: an image capturing apparatus 3 and an image processing apparatus 4. The image capturing apparatus 3 is used for capturing images of a fingerprint 91 of a fingertip 9. The image processing apparatus 4 is connected to the image capturing apparatus 3 for receiving the images for subsequent operation in a finger recognition mode or a finger navigation mode.

As shown in FIG. 2, the image capturing apparatus 3 includes an optical component 31, a light source module 32, and an imaging unit 33. The optical component 31 has an elongate sensing surface 311 on which a fingertip 9 with a fingerprint 91 may be placed. The sensing surface 311 has a width of at least one side that is smaller than the fingertip 9. The optical component 31 further includes a total internal reflection surface 312 disposed opposite to the sensing surface 311, and an inclined reflection surface 313 connected to the sensing surface 311 and the total internal reflection surface 312, and that forms an acute angle with the total internal reflection surface 312. The optical component 31 also includes a light exit surface 314 disposed opposite the inclined reflection surface 313.

In this embodiment, the sensing surface 311 is disposed above the total internal reflection surface 312, and the inclined reflection surface 313 and the light exit surface 314 are disposed horizontally opposite to each other. The preferred range for the angle between the total internal reflection surface 312 and the inclined reflection surface 313 is 65˜75 degrees.

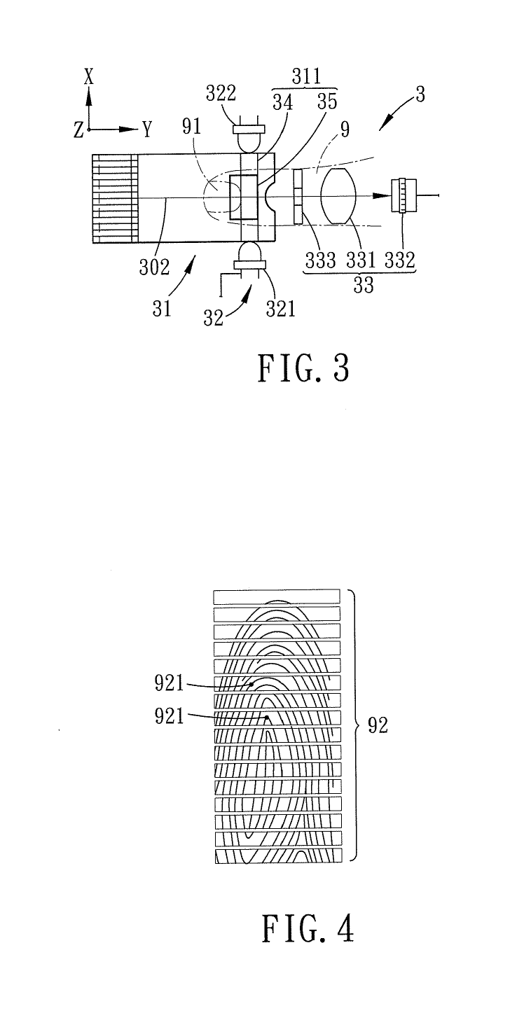

Referring further to FIG. 3, the sensing surface 311 includes a first image sensing region 34 and a second image sensing region 35. The first image sensing region 34 is used for the finger recognition mode, and the second image sensing region 35 is used for the finger navigation mode. The first image sensing region 34 has a width larger than or equal to that of the second image sensing region 35.

The light source module 32 is disposed to provide a light beam 301 to the optical component 31. In this embodiment, referring again to FIGS. 2 and 3, the light source module 32 includes a first light source 321 disposed proximate to a lower portion of a lateral side of the sensing surface 311, and a second light source 322 disposed proximate to a lower portion of another lateral side of the sensing surface 311. In other words, the first and second light sources 321, 322 are disposed at respective opposite lateral sides of the optical component 31. In this embodiment, each of the first light source 321 and the second light source 322 can be a single light emitting diode (LED) or multiple LEDs, respectively, but are not limited to these configurations.

The imaging unit 33 includes an imaging lens 331 disposed to receive light from the light exit surface 314, and an imaging sensor 332 disposed to receive light that passes through the imaging lens 331 to form a fingerprint image. In this embodiment, the imaging sensor 332 can be a CCD (Charge Coupled Device), a CMOS (Complimentary Metal Oxide Semiconductor Sensor) or any other type of optical sensor known in the art. Preferably, the imaging unit 33 further includes an aperture stop 333 disposed between the light exit surface 314 and the imaging lens 331 for adjusting the lumen of light passing through the imaging lens 331 so that the imaging sensor 332 can get a better image.

The optical path of the image capturing apparatus 3 is described below. The fingerprint 91 of the fingertip 9 includes ridges 911 and valleys 912. As shown in FIG. 2, when the light source module 32 provides the light beam 301 to illuminate the sensing surface 311, part of the light beam 301 is scattered by the ridges 911 of the fingerprint 91 of the fingertip 9 placed on the sensing surface 311. The scattered light components 302 from the ridges 911 are reflected through total internal reflection by the total internal reflection surface 312 toward the inclined reflection surface 313, which in turn reflects the scattered light components 302 from the ridges 911 through the light exit surface 314. The scattered light components 302 then pass through the aperture stop 333 before being focused by the imaging lens 331 to form an image at the imaging sensor 332. The imaging sensor 332 uses the imaging lens 331 to capture the scattered light components 302 from the imaging lens 331 to form images of the fingerprint 91 of the fingertip 9. Preferably, the light exit surface 314 is a cylindrical surface with a negative curvature for adjusting the vertical and horizontal distortion of the fingerprint images. The light exit surface 314 may also be a spherical surface, a flat surface, or any other shape. Either the light exit surface 314, a processing program or circuit, or a combination of the light exit surface 314 and a processing program or circuit may be used to correct the distortion of the fingerprint images.

The scattered light components 302 from the ridges 911 of the fingerprint 91 are received by the imaging sensor 332, whereas the scattered light components 303 of the light beam 301 are scattered from the valleys 912 of the fingerprint 91 such that they pass through the total internal reflection surface 312 to the outside environment. Hence, the scattered light components 303 scattered from the valleys 912 are not received by the imaging sensor 332. The imaging sensor 332 thus, in this embodiment, only receives the scattered light components 302 scattered from the ridges 911, which allows the fingerprint imaging system 2 to acquire fingerprint images with better contrast than the prior art. In variations of this embodiment, a major proportion of the light received by the imaging sensor 332 is composed of the scattered light components 302 scattered from the ridges 911 of the fingerprint 91 rather than the scattered light components 303 scattered from the valleys 912, which improves the contrast of the fingerprint images obtained over the prior art.

The sensing surface 311 is designed to have an elongate strip shape with a length that corresponds to either the width or the length of the fingertip 9. Thus, the image capturing apparatus 3 is designed to have a structure that occupies less volume than the conventional fingerprint imaging system.

Referring again to FIG. 2, the image processing apparatus 4 has a first processing unit 41 for conducting a finger recognition mode and a second processing unit 42 for conducting a finger navigation mode. When the fingertip 9 moves over the sensing surface 311, the imaging sensor 332 captures a plurality of consecutive images, as shown in FIG. 4.

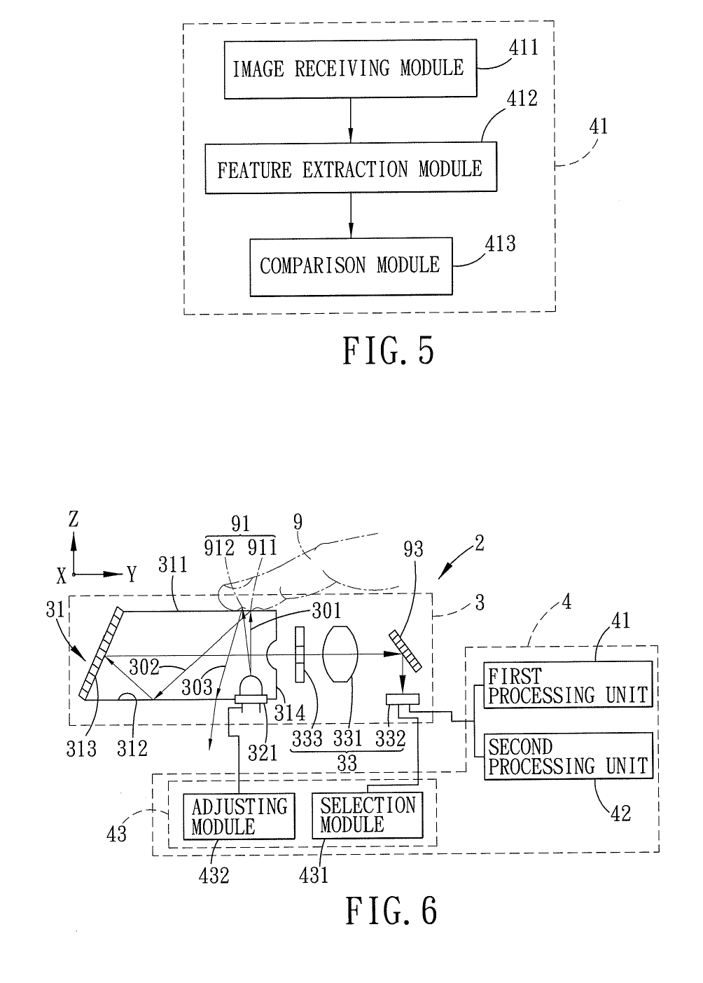

As shown in FIG. 5, the first processing unit 41 has an image receiving module 411 for storing consecutive ones of the fingerprint images of the fingertip 9 placed on the sensing surface 311, and composing the full fingerprint pattern 92 (see FIG. 4) of the fingerprint 91 placed on the sensing surface 311. The consecutive fingerprint images are acquired by the imaging sensor 332 when the fingertip 9 is moved transverse to the sensing surface 311. The first processing unit 41 further includes a feature extraction module 412 and a comparison module 413. The feature extraction module 412 is coupled to the image receiving module 411 for extracting at least one feature 921 (see FIG. 4) from the fingerprint pattern 92. The comparison module 413 is coupled to the feature extraction module 412 for comparing the feature 921 with other fingerprint patterns 92 stored in a memory module (not shown) of the electronic product for the user's identification of the user.

In this embodiment, the aforementioned modules are software programs that are processed by a central processing unit (CPU) (not shown in the Figure) of the electronic product. In practice, the CPU may be replaced by a proprietary finger recognition processor that may be more efficient.

In the finger navigation mode, the fingertip 9 may move along two transverse axes across the sensing surface 311 to generate a plurality of consecutive images. The second processing unit 42 determines a displacement distance (Δx, Δy) of the fingertip 9 relative to the sensing surface 311 from the consecutive images. Thereafter, the central processing unit (CPU) of the electronic product controls a cursor on a screen by the relative displacement amount for conducting the finger navigation mode. In this embodiment, the second processing unit 42 is realized using a processor to calculate the (Δx, Δy) and send these data to electronic device.

Moreover, the image processing apparatus 4 further includes a control unit 43 that has a selection module 431 coupled to the imaging sensor 332 and an adjusting module 432 coupled between the imaging sensor 332 and the light source module 32. In this embodiment, the selection module 431 and the adjusting module 432 are realized using circuits.

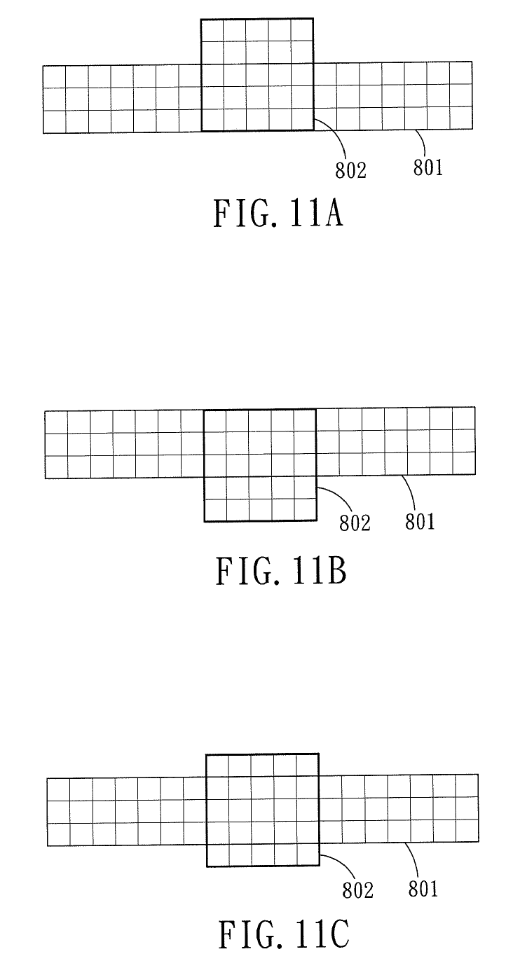

In the finger navigation mode, the full width of the first image sensing region 34 is not needed to acquire images of the fingerprint 91. Hence, the second image sensing region 35 of the sensing surface 311 has a smaller width than the first image sensing region 34 for operating in the finger navigation mode. Referring to FIG. 11A, when the image processing apparatus 4 operates in the finger recognition mode, the selection module 431 selects a first photo detector array 801 of the imaging sensor 332 that corresponds to the first image sensing region 34 of the sensing surface 311 for imaging. The images generated by the imaging sensor 332 then correspond to the fingerprint 91 over the first image sensing region 34. When the image processing apparatus 4 operates in the finger navigation mode, the selection module 431 selects a second photo detector array 802 of the imaging sensor 332 that corresponds to the second image sensing region 35 of the sensing surface 311 for imaging. The image generated by the imaging sensor 332 then corresponds to the fingerprint 91 over the second image sensing region 35. As long as the width of the first image sensing region 34 is larger than that of the second image sensing region 35, the first photo detector array 801 and the second photo detector array 802 may also have other configurations in other embodiments, as shown in FIG. 11B and FIG. 11C. The adjusting module 432 is used to adjust the lumen of the light source module 32 when the image processing apparatus 4 conducts the finger recognition mode or the finger navigation mode.

In an example embodiment, the fingerprint imaging system 2 may be part of a mobile phone. When the mobile phone is turned on, the internal software operates the fingerprint imaging system 2 in the finger recognition mode to confirm the user's identity and to authorize further use. After the user's identity is confirmed, the internal software operates the fingerprint imaging system 2 in the finger navigation mode. The user may move his/her fingertip 9 across the sensing surface 311 to control a cursor shown on a screen of the mobile phone. Later, when the user uses the mobile phone to connect to a network and is requested to provide on-line account identification, the internal software again operates the fingerprint imaging system 2 in the finger recognition mode. The fingerprint imaging system 2 may therefore be used to integrate the functions of finger recognition and finger navigation on the electronic product (e.g., the mobile phone of this example).

FIG. 6 illustrates a modification of the first preferred embodiment in which a mirror 93 is disposed in the optical path between the imaging lens 331 and the imaging sensor 332. The mirror 93 reflects the scattered light component 302 from the imaging lens 331 to the imaging sensor 332 disposed below the mirror 93, thus bending the optical path of the first preferred embodiment and further shortening the physical length of the image capturing apparatus 3.

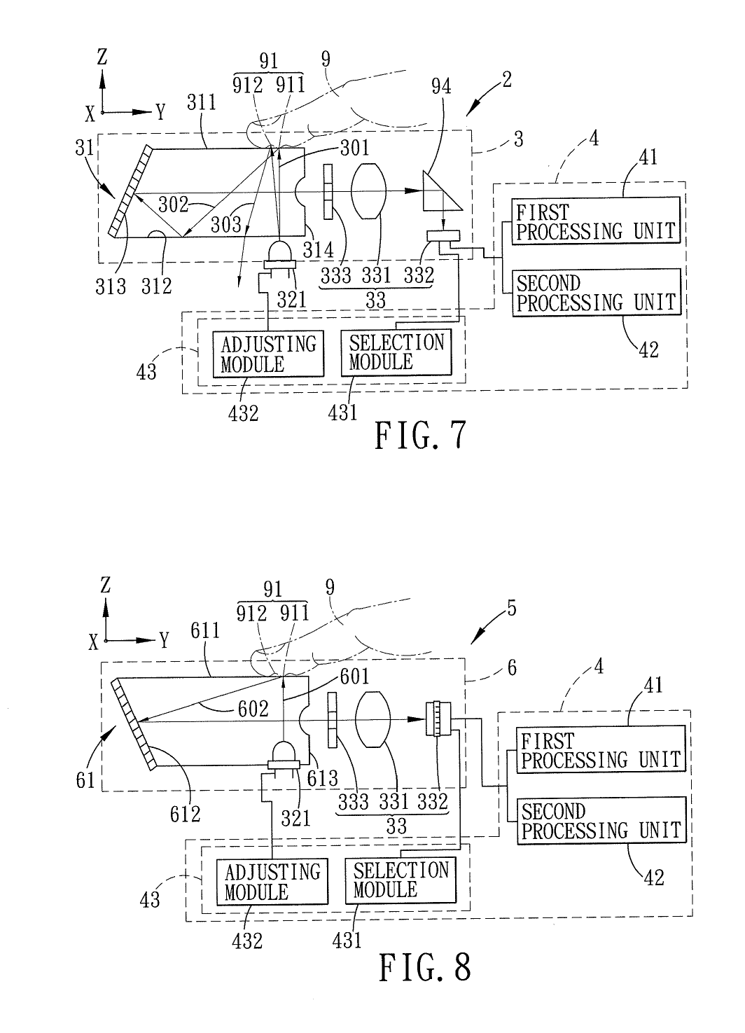

FIG. 7 illustrates another modification of the first preferred embodiment in which a prism 94 rather than a mirror 93 is disposed in the optical path between the imaging lens 331 and the imaging sensor 332. The prism 94 reflects the scattered light component 302 from the imaging lens 331 to the imaging sensor 332 disposed below the prism 94, thus bending the optical path of the first preferred embodiment and further shortening the physical length of the image capturing apparatus 3. In addition, the light source module 32 is disposed below the optical component 31 for illuminating the sensing surface 311 of the optical component 31.

Referring to FIG. 8, the second preferred embodiment of the fingerprint imaging system 5 for finger recognition and finger navigation is shown to include an image capturing apparatus 6 and the image processing apparatus 4. The image capturing apparatus 6 is used for capturing images of the fingerprint 91 of the fingertip 9. The image processing apparatus 4 is connected to the image capturing apparatus 6 for receiving the images therefrom for subsequent operation in the finger recognition mode and the finger navigation mode. The second preferred embodiment is generally identical to the first preferred embodiment in structure, and only differs in the reflecting mechanism of the image capturing apparatus 6 described in greater detail below.

The image capturing apparatus 6 includes an optical component 61, a light source module 32 and an imaging unit 33. The optical component 61 has an elongate sensing surface 611 on which the fingertip 9 with the fingerprint 91 may be placed, and which has a width of at least one side that is smaller than the fingertip 9. The optical component 61 also has an inclined reflection surface 612 connected at an acute angle to the sensing surface 611, and a light exit surface 613 disposed opposite the inclined reflection surface 612. The preferred range for the angle between the sensing surface 611 and the inclined reflection surface 612 is 45˜50 degrees.

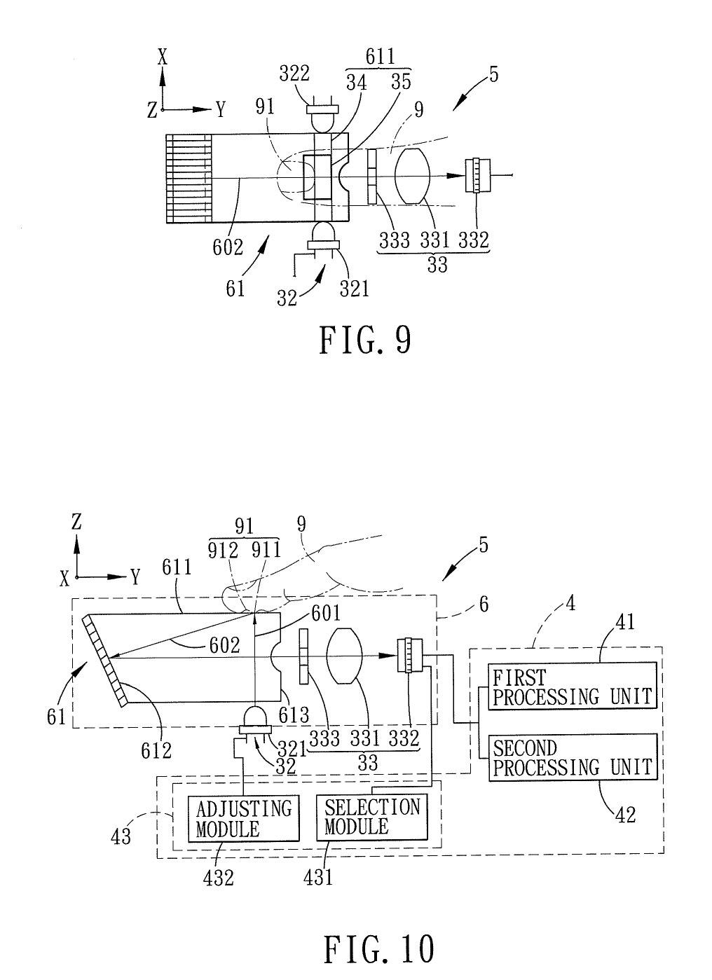

Referring to FIG. 9, the sensing surface 611 includes the first image sensing region 34 and the second image sensing region 35. The first image sensing region 34 is used for the finger recognition mode, and the second image sensing region 35 is used for the finger navigation mode. The width of the first image sensing region 34 is larger than or equal to the second image sensing region 35.

The light source module 32 and the imaging unit 33 are identical to the corresponding components of the first preferred embodiment. The light source module 32 includes the first light source 321 disposed proximate to a lower portion of a lateral side of the sensing surface 611, and the second light source 322 disposed proximate to a lower portion of another lateral side of the sensing surface 611. In other words, the first and second light sources 321, 322 are disposed at respective opposite lateral sides of the optical component 61. The imaging unit 33 includes the imaging lens 331, the imaging sensor 332, and the aperture stop 333. The imaging lens is disposed to receive light from the light exit surface 613, the imaging sensor 332 is disposed to receive light that passes through the imaging lens 331, and the aperture stop 333 is disposed between the light exit surface 613 and the imaging lens 331.

The optical path of the image capturing apparatus 6 is presented below. When the light source module 32 provides the light beam 601 to illuminate the sensing surface 611, part of the light stream 601 is scattered by the ridges 911 of the fingerprint 91 placed over the sensing surface 611, and the scattered light components 602 are reflected by the inclined reflection surface 612 to exit through the light exit surface 613. The scattered light components 602 then pass through the aperture stop 333 before being focused by the imaging lens 331 to form an image at the imaging sensor 332. The imaging sensor 332 uses the imaging lens 331 for capturing the scattered light components 602 from the imaging lens 331 to form images of the fingerprint 91 of the fingertip 9. The scattered light components (not shown) scattered by the valleys 912 pass through the bottom side of the optical component 61. The image capturing apparatus 6 therefore also enables capture of a fingerprint image with improved contrast over the prior art. Preferably, the light exit surface 613 is a cylindrical surface with a negative curvature for adjusting the vertical and horizontal distortion of the fingerprint images. The light exit surface 613 may also be a spherical globe surface, a curved surface, a flat surface, or any other shape. Either the light exit surface 613, a processing program or circuit, or a combination of the light exit surface 613 and a processing program or circuit may be used to correct the distortion of the fingerprint images.

The image processing apparatus 4 utilizes the images acquired from the image capturing apparatus 6 for conducting the finger recognition mode and the finger navigation mode such that the fingerprint imaging system achieves the same effect accomplished by the fingerprint imaging system 2 of the first preferred embodiment.

FIG. 10 illustrates a modification of the second preferred embodiment in which the light source module is disposed below the optical component 61 for illuminating the sensing surface 611 of the optical component 61, which also accomplishes the same effect achieved by the first preferred embodiment.

In summary, the design of the optical component 31, 61, permits the imaging sensor 332 of the imaging unit 33 to receive only the scattered light components 302, 602 reflected from the ridges 911 of the fingerprint 91, such that images received by the imaging sensor 332 have better contrast quality over the prior art. As such, the image processing apparatus 4 can therefore provide improved finger recognition and finger navigation. Moreover, the design of the optical component 31, 61 permits further miniaturization of the image capturing apparatus 3, 6 with respect to the prior art.

While the present invention has been described in connection with what are considered the most practical and preferred embodiments, it is understood that this invention is not limited to the disclosed embodiments but is intended to cover various arrangements included within the spirit and scope of the broadest interpretation to encompass all such modifications and equivalent arrangements.

What is claimed is:

1. A fingerprint imaging system comprising:
an image capturing apparatus including
an optical component having a sensing surface for placing a fingertip thereon, said sensing surface being in a form of an elongated strip that is smaller than the tip of the human finger in at least one dimension, a total internal reflection surface that is disposed opposite to said sensing surface, an inclined reflection surface that is connected to said sensing surface and said total internal reflection surface and that forms an acute angle with said total internal reflection surface, and a light exit surface that is disposed opposite to said inclined reflection surface,
a light source module for directing a light beam towards said sensing surface for scattering by a fingerprint of the fingertip placed on said sensing surface,
wherein said light source module, said sensing surface, said total internal reflection surface, said inclined reflection surface and said light exit surface are disposed such that light scattered by a plurality of ridges of the fingerprint form a first light component that is reflected through total internal reflection to said inclined reflection surface so as to exit said optical component through said light exit surface, and such that light scattered by a plurality of valleys of the fingerprint form a second light component that passes through said total internal reflection surface, and
an imaging unit including an imaging lens disposed to receive light from said light exit surface, and an imaging sensor disposed to receive light that passes through said imaging lens so as to form a fingerprint image; and
an image processing apparatus coupled to said imaging sensor for receiving the fingerprint image therefrom.

2. The fingerprint imaging system of claim 1, wherein:
the fingerprint image from said imaging unit corresponds to a widthwise section of a full fingerprint pattern of the fingerprint placed on said sensing surface;
said image processing apparatus including a first processing unit operable in a finger recognition mode, said first processing unit having
an image receiving module for storing consecutive ones of the fingerprint images of the fingertip placed on said sensing surface, said consecutive ones of the fingerprint images being acquired by said imaging sensor when the fingertip is moved transverse to said sensing surface and composing the full fingerprint pattern of the fingerprint placed on said sensing surface,
a feature extracting module coupled to said image receiving module for extracting at least one feature of the full fingerprint pattern, and
a comparison module for comparing the at least one feature of the full fingerprint pattern with a pre-established data set for identification of the fingerprint.

3. The fingerprint imaging system of claim 2, wherein said image processing apparatus further includes a second processing unit operable in a finger navigation mode for generating a cursor control signal based on a relative displacement of the fingertip relative to said sensing surface, the relative displacement being determined through analyzing said consecutive ones of the fingerprint images acquired by said imaging sensor.

4. The fingerprint imaging system of claim 3, wherein said sensing surface includes a first image sensing region for the finger recognition mode, and a second image sensing region for the finger navigation mode.

5. The fingerprint imaging system of claim 1, wherein:
one side of said sensing surface is smaller than that of the fingertip placed thereon;
the fingerprint image from said imaging unit corresponding to a section of a full fingerprint pattern of the fingerprint placed on said sensing surface;
said image processing apparatus including a processing unit operable in a finger navigation mode for generating a cursor control signal based on a relative displacement of the fingertip relative to said sensing surface, the relative displacement being determined through analyzing said consecutive ones of the fingerprint images acquired by said imaging sensor.

6. The fingerprint imaging system of claim 1, wherein said optical component includes a pair of lateral walls, each connected between corresponding lateral sides of said sensing surface and said total internal reflection surface, and
said light source module includes first and second light sources each disposed proximate to a lower portion of a corresponding one of said lateral walls of said optical component.

7. The fingerprint imaging system of claim 1, wherein said light source module is disposed below said optical component for illuminating said sensing surface.

8. The fingerprint imaging system of claim 1, wherein said light exit surface is formed with a negative curvature.

9. The fingerprint imaging system of claim 1, wherein said imaging unit further includes an aperture stop disposed between said light exit surface and said imaging lens.

10. A fingerprint imaging system comprising:
an image capturing apparatus including
an optical component having a sensing surface for placing a fingertip thereon, said sensing surface being in a form of an elongated strip that is smaller than the tip of the human finger in at least one dimension, an inclined reflection surface that is connected to said sensing surface at an acute angle, and a light exit surface that is disposed opposite to said inclined reflection surface,
a light source module for directing a light beam towards said sensing surface for scattering by a fingerprint of the fingertip placed on said sensing surface,
wherein said light source module, said sensing surface, said inclined reflection surface and said light exit surface are disposed such that light scattered by a plurality of ridges of the fingerprint form a first light component that is reflected by said inclined reflection surface so as to exit said optical component through said light exit surface, and such that light scattered by a plurality of valleys of the fingerprint form a second light component that is not reflected by said inclined reflection surface for exiting through said light exit surface, and
an imaging unit including an imaging lens disposed to receive light from said light exit surface, and an imaging sensor disposed to receive light that passes through said imaging lens so as to form a fingerprint image; and
an image processing apparatus coupled to said imaging sensor for receiving the fingerprint image therefrom.

11. The fingerprint imaging system of claim 10, wherein:
the fingerprint image from said imaging unit corresponds to a widthwise section of a full fingerprint pattern of the fingerprint placed on said sensing surface;
said image processing apparatus including a first processing unit operable in a finger recognition mode, said first processing unit having
an image receiving module for storing consecutive ones of the fingerprint images of the fingertip placed on said sensing surface, said consecutive ones of the fingerprint images being acquired by said imaging sensor when the fingertip is moved transverse to said sensing surface and composing the full fingerprint pattern of the fingerprint placed on said sensing surface,
a feature extracting module coupled to said image receiving module for extracting at least one feature of the full fingerprint pattern, and
a comparison module for comparing the at least one feature of the full fingerprint pattern with a pre-established data set for identification of the fingerprint.

12. The fingerprint imaging system of claim 11, wherein said image processing apparatus further includes a second processing unit operable in a finger navigation mode for generating a cursor control signal based on a relative displacement of the fingertip relative to said sensing surface, the relative displacement being determined through analyzing said consecutive ones of the fingerprint images acquired by said imaging sensor.

13. The fingerprint imaging system of claim 12, wherein said sensing surface includes a first image sensing region for the finger recognition mode, and a second image sensing region for the finger navigation mode.

14. The fingerprint imaging system of claim 10, wherein:
One side of said sensing surface is smaller than that of the fingertip placed thereon;
the fingerprint image from said imaging unit corresponding to a section of a full fingerprint pattern of the fingerprint placed on said sensing surface;
said image processing apparatus including a processing unit operable in a finger navigation mode for generating a cursor control signal based on a relative displacement of the fingertip relative to said sensing surface, the relative displacement being determined through analyzing said consecutive ones of the fingerprint images acquired by said imaging sensor.

15. The fingerprint imaging system of claim 10, wherein said optical component includes a pair of lateral walls, each connected to a corresponding lateral side of said sensing surface, and
said light source module includes first and second light sources each disposed proximate to a lower portion of a corresponding one of said lateral walls of said optical component.

16. The fingerprint imaging system of claim 10, wherein said light source module is disposed below said optical component for illuminating said sensing surface.

17. The fingerprint imaging system of claim 10, wherein said light exit surface is formed with a negative curvature.

18. The fingerprint imaging system of claim 10, wherein said imaging unit further includes an aperture stop disposed between said light exit surface and said imaging lens.
